(19) United States
(12) Patent Application Publication
(10) Pub. No.: US 2011/0036646 A1
(43) Pub. Date: Feb. 17, 2011

(54) SUSPENSION ADAPTATION TO MEASURE LOAD OF A COMMERCIAL VEHICLE

(76) Inventor: STEVEN DACK, Escalon, CA (US)

Correspondence Address: Raj Abhyanker, P.C., 1580 West, El Camino Real, Suite 8, Mountain View, CA, 94040, US

(21) Appl. No.: 12/540,382

(22) Filed: Aug. 13, 2009

(51) Int. Cl. G01G 19/08; G01G 23/01

(52) U.S. Cl. 177/136; 73/1.13

(57) ABSTRACT

A method and system of a suspension adaptation to measure load of a commercial vehicle are disclosed. In one embodiment, a load measurement method includes loading a commercial vehicle with a weight, compressing a spring suspension system of the commercial vehicle using the weight, and determining the weight using a gas compression device and a vertical change in position of the commercial vehicle. The method further includes acquiring a pressure of the gas compression device to determine a loading level of the commercial vehicle.

### FIELD OF TECHNOLOGY

This disclosure relates generally to commercial vehicle loading. More particularly, this invention relates to a suspension adaptation to measure load of a commercial vehicle.

### BACKGROUND

A loaded weight of a commercial vehicle with a spring suspension may be determined to allow the vehicle to carry cargo in accordance with a governmental regulation. The commercial vehicle may be weighed by driving the commercial vehicle to a weigh station, waiting in line with other commercial vehicles before being weighed, and placed on an in-ground scale.

If the loaded content of the commercial vehicle is above a legal limit, a fine may be levied based on the amount of cargo weight carried by the commercial vehicle in excess of the legal limit. Cargo of the commercial vehicle may be removed or adjusted to comply with the legal limit and to allow the commercial vehicle to transport goods, passengers, or deliverable items.

Unloading the commercial vehicle may include driving the commercial vehicle to another location where offloaded goods may be received. The actual weight of the commercial vehicle may be inaccurately estimated, and an insufficient or an excessive amount of cargo may be removed from the commercial vehicle. The commercial vehicle may then be returned to the weigh station to be reweighed to determine whether the commercial vehicle's weight exceeds, meets, or falls below the legal limit. Unloading, estimating the commercial vehicle's weight, returning to the weigh station, waiting in line for the commercial vehicle to be reweighed, and reweighing the commercial vehicle may consume time and result in a loss of revenue associated with delivering cargo. In addition, if the commercial vehicle is substantially below the legal limit after weighing and/or reweighing the commercial vehicle, the commercial vehicle may transport goods with excess unused cargo capacity, resulting in an additional loss of revenue.

A spring suspension may be installed on a commercial vehicle rather than an alternative suspension due to a purchase cost, an installation complexity, a maintenance cost, and/or a reliability limit. In addition, a commercial vehicle weight may be estimated rather than measured due to a weight sensor's cost, installation difficulty, maintenance cost, and/or a reliability limit. For example, a weight sensor may be installed at a top end and/or a bottom part of a spring. The weight sensor may include a substantial cost, parts subject to vibration and/or impact, and may ultimately fail due to wear and tear on the weight sensor. In addition, the weight sensor may require professional installation, calibration, and/or maintenance. A failure of the weight sensor may therefore result in a further loss of revenue that exceeds the benefit obtained by using the weight sensor.

### SUMMARY

A method and system of a suspension adaptation to measure load of a commercial vehicle are disclosed. In an aspect, a method includes loading a commercial vehicle with a weight, and compressing a spring suspension system of the commercial vehicle using the weight. The method further includes determining the weight using a gas compression device and a vertical change in position of the commercial vehicle, and acquiring a pressure of the gas compression device to determine a loading level of the commercial vehicle.

The spring suspension system may include a leaf spring suspension, and the method may include limiting a loading of the commercial vehicle when the pressure has reached a calibration threshold. The calibration threshold may correspond to a weight limit established by a government standard. The vertical change in position may be measured using a compression distance of the spring suspension system. The spring suspension system may include a leaf spring.

The gas compression device may be mechanically coupled to an axle and a frame of the commercial vehicle. The gas compression device may be an automotive air shock. The automotive air shock may include an adjustable pressure range between 10 and 200 pounds per square inch. The method may further include balancing a pressure change between a gas compression device and an additional gas compression device. The gas compression device and the additional gas compression device may be mounted on different sides of the commercial vehicle. The method may further include reducing an unloaded movement of the spring suspension system by using the gas compression device to apply a force between a frame and an axle of the commercial vehicle.

In another aspect, a load measurement system includes a commercial vehicle that is loaded with a weight. The load measurement system also includes a spring suspension system of the commercial vehicle that is compressed using the weight. The load measurement system further includes a gas compression device that is used to determine the weight and a vertical change in position of the commercial vehicle. The load measurement system includes a pressure monitor to acquire a pressure of the gas compression device to determine a loading level of the commercial vehicle.

The spring suspension system may include a leaf spring suspension. The loading of the commercial vehicle may be limited when the pressure has reached a calibration threshold. The calibration threshold may correspond to a weight limit established by a government standard. The vertical change in position may be measured using a compression distance of the spring suspension system. The spring suspension system may include a leaf spring. The gas compression device may be mechanically coupled to an axle and a frame of the commercial vehicle. The gas compression device may be an automotive air shock.

In yet another aspect, a load measurement method includes loading a commercial vehicle with a weight and compressing a leaf spring suspension system of the commercial vehicle using the weight. The load measurement method further includes balancing a pressure change between a gas compression device and an additional gas compression device. The gas compression device and the additional gas compression device are mounted on different sides of the commercial vehicle.

In the aspect, the method further includes determining the weight using a gas compression device and a vertical change in position of the commercial vehicle. The vertical change in position is measured using a compression distance of the spring suspension system. The method also includes acquiring a pressure of the gas compression device to determine a loading level of the commercial vehicle.

The gas compression device is mechanically coupled to an axle and a frame of the commercial vehicle. The gas compression device is an automotive air shock with an adjustable pressure range between 10 and 200 pounds per square inch. The method also includes limiting a loading of the commercial vehicle when the pressure has reached a calibration threshold that corresponds to a weight limit established by a government standard. In addition, the method includes reducing an unloaded movement of the spring suspension system by applying a force between a frame and an axle of the commercial vehicle using the gas compression device.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying Drawings and from the Detailed Description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a perspective view of a commercial vehicle, according to one embodiment.

FIGS. 2A and 2B illustrate a side view of a suspension adaptation to measure load of the commercial vehicle of FIG. 1, according to an embodiment.

FIG. 3 illustrates a rear view of a suspension adaptation to measure load of the commercial vehicle of FIG. 1, according to an embodiment.

FIG. 4 illustrates a gas compression device, according to one embodiment.

FIG. 5 illustrates a process flow to determine a weight using a gas compression device and a vertical change in position, according to one embodiment.

FIG. 6 illustrates a process flow to control a loading of the commercial vehicle when a pressure has reached a calibration threshold, according to one embodiment.

Other features of the present embodiments will be apparent from the accompanying drawings and from the detailed description that follows.

### DETAILED DESCRIPTION

A method and system of a suspension adaptation to measure load of a commercial vehicle are disclosed. Although the present embodiments have been described with reference to specific example embodiments, it will be evident that various modifications and changes may be made to these embodiments without departing from the broader spirit and scope of the various embodiments. Furthermore, although specific values may be provided in example embodiments and figures, it is understood that the numbers need not be exact and are used to convey the general concept of the method and system of a suspension adaptation to measure load of a commercial vehicle.

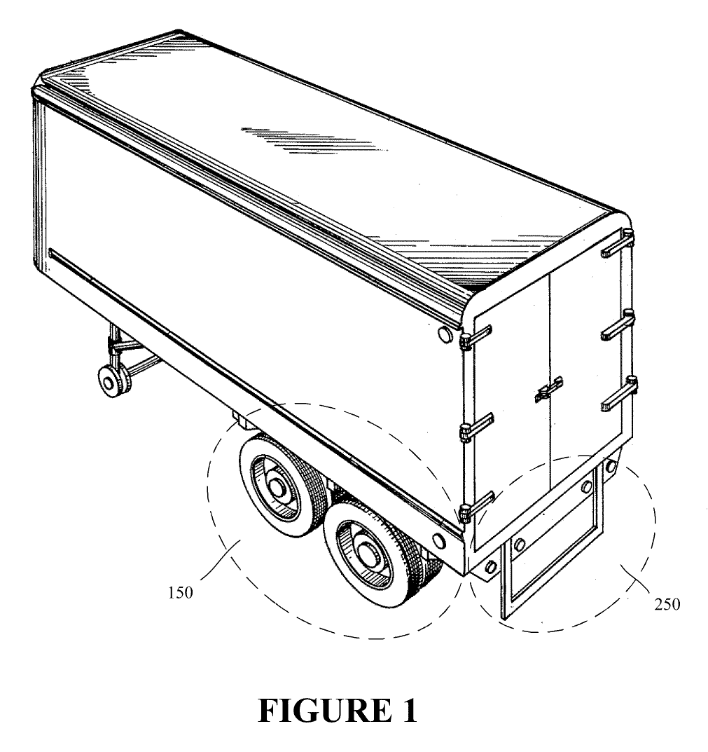

FIG. 1 illustrates a perspective view of a commercial vehicle, according to one embodiment. In particular, FIG. 1 illustrates a side view 150 and a rear view 250. The commercial vehicle may be a tractor unit, a trailer, a bus, a truck, a dolly, and/or any combination of the tractor unit, and the trailer. The commercial vehicle may include a vehicle engaged in interstate or intrastate commerce that is used to transport passengers or property. The commercial vehicle may have a gross vehicle weight of 10,001 pounds (4,536 kg) or more. The commercial vehicle may be designed or used to transport more than 8 passengers (including the driver) for compensation, or be designed or used to transport more than 15 passengers (including the driver) without compensation. The commercial vehicle may be used to transport hazardous materials in quantities requiring the vehicle to be marked or placarded under hazardous materials regulations.

The tractor unit may pull one or more trailers and may be equipped with a diesel engine, a hybrid engine, an electric motor, and/or any other type of engine. The tractor unit may be standardized to pull a variety of trailers. The tractor-trailer combination may allow a load to be shared across many axles. The tractor unit may be coupled to the trailer using a mechanical lock system, such as a fifth wheel. A fifth wheel coupling may provide a link between a semi-trailer and a towing truck, tractor unit, leading trailer, and/or the dolly. The fifth wheel coupling may include a coupling pin or king pin and a horseshoe-shaped coupling device called a fifth wheel on the rear of a towing vehicle.

In North America, semi tractors may frequently have three axles, including a front axle and two rear axles. The front axle may act as a steering axle, and the two rear axles may be drive axles. The front axle may have two wheels, while the two rear axles may have a pair of wheels (e.g., dual wheels) on each side, making a total of ten wheels. In other configurations, super singles or wide base singles may be used instead of pairs of wheels to reduce the weight of the tractor. In another embodiment, a tractor may have a single drive axle, and it may be used in an urban environment rather than on open freeways.

Although dual wheels on tractor and trailer axles may frequently be used, the use of two single, wider tires (e.g., super singles) on each axle may also be used, particularly among bulk cargo carriers and weight-sensitive operators. Super singles may allow a truck to be loaded with more freight, and a single wheel may cover less of a brake unit, which may allow faster cooling and reduce brake fade. In the event of a tire disablement, however, the super single configuration may prevent a vehicle from being driven to a repair facility without damaging the rim, which may be performed with disablement of one of a pair of dual wheels.

The tractor may pull the trailer that can carry cargo. The trailer may have a pair of axles at a rear end of the trailer, which may be described as “tandem” axles. Each of the axles of the trailer may have a pair of wheels at each end of the axle, making a total of eight wheels used with the trailer. The trailer may be equipped with movable tandems and fifth wheels to allow adjustment of the weight on each axle. National, state, or other government regulations may limit the allowable weight of each axle, and moving the tandems may assist with improving weight distribution.

Rules governing the maximum size and weight of vehicles may differ between states in the US and various countries, but trucks and trailers within the United States may frequently be built to the specifications of the Department of Transportation (DOT). Rules may limit the size and weight of vehicles operated on the United States interstate system. The DOT vehicle limits may include a restriction to 102 inches of width and 13.5 feet of height.

A division of the DOT, the Federal Motor Carrier Safety Administration (FMCSA), may regulate safety for the U.S. trucking industry. The FMCSA may regulate the length, width, and weight limits of commercial vehicles for interstate commercial traffic. Interstate commercial traffic may generally be limited to a network of Interstate Highways, U.S. highways, and state highways known as the National Network. State limits can be lower or higher than federal limits, and may apply if the vehicle is traveling on a road outside of the National Network.

Commercial vehicles may be restricted by gross weight and/or by axle weight. Gross weight may be the total weight of vehicle and cargo, and axle weight may be the weight carried by axle. The federal weight limits for commercial vehicles may be 80,000 pounds (36,000 kg) for gross weight (unless the bridge formula dictates a lower limit), 34,000 pounds (15,000 kg) for a tandem axle, and 20,000 pounds (9,100 kg) for a single axle. A tandem axle may be defined as two or more consecutive axles whose centers are spaced more than 40 inches (100 cm) but not more than 96 inches (240 cm) apart. Axles spaced less than 40 inches (100 cm) apart may be considered a single axle.

In effect, the formula may reduce the legal weight limit for shorter trucks with fewer axles. For example, a 25-foot (7.6 m) three-axle dump truck would have a gross weight limit of 54,500 pounds (24,700 kg), instead of 80,000 pounds (36,000 kg), which may be the standard weight limit for 63-foot (19 m) five-axle tractor-trailer. These limits can be exceeded within individual states, which may impose different requirements or issue temporary oversize and/or overweight permits.

The DOT may use the Federal Bridge Gross Weight Formula (also known as Bridge Formula B and the Federal Bridge Formula) to determine the appropriate maximum gross weight for a commercial vehicle based on axle spacing. The formula may be part of federal weight and size regulations regarding interstate commercial traffic. The formula may help prevent heavy vehicles from damaging roads and bridges. The formula may effectively lower the legal weight limit for shorter trucks, preventing them from causing premature deterioration of bridges and highway infrastructure. Compliance with the law may be checked when vehicles pass through a weigh station, which may often be located at the borders between states or on the outskirts of major cities. Weigh stations may be run by state departments of transportation, and commercial vehicle weight and size enforcement may be overseen by the Federal Highway Administration (FHWA). Weigh stations may check each vehicle's gross weight and axle weight using a set of in-ground truck scales.

Federal and/or state rules may establish limitations on the movement or operation of a commercial vehicle or combination of commercial vehicles on an interstate highway based on the gross weight on two or more consecutive axles using the following formula:

$$w = 500 ( \frac{l \cdot n}{n - 1} + 12 n + 36 )$$

In an embodiment, “w” is the upper threshold weight in pounds that can be carried on a group of two or more axles to the nearest 500 pounds (230 kg), “l” is the spacing in feet between the outer axles of any two or more consecutive axles, and “n” is the number of axles considered. In the embodiment, two or more consecutive axles may be limited to the weight computed by the bridge formula, even if the gross weight of the truck (or the weight on one axle) is below otherwise legal limits.

Penalties for violating weight limits may vary between states. Some states may issue fines on a percentage basis (e.g. 20% overweight at $10 per 100 pounds/45 kilograms), which means larger trucks may pay higher fines. Other states may issue fines on a per-pound basis (e.g., 5,000 pounds overweight equals a $300 fine). Other states may use a fine schedule in which a vehicle that violates the limits by less than 10,000 pounds (4,500 kg) is fined $40 per 100 pounds, while a violation over 10,000 pounds pays $80 per 100 pounds (e.g. 5,000 pounds overweight equals a $200 fine).

Some states may require overweight trucks to offload enough cargo to comply with the limits. States may include a tolerance, in which violations of less than a threshold percentage (e.g., 10% of the allowable weight limit) may be forgiven. States may allow load shifting (e.g., from front to rear) to allow compliance with axle weight limits without penalty.

Advantages of semi-trailers may include trailers that may be coupled and uncoupled to allow loading and transfer between depots. In addition, in the event of a breakdown, a tractor unit may be exchanged without having to unload and reload a commercial vehicle's cargo. A dolly may be used to tow a semi-trailer behind another type of truck. Compared to a full scale trailer, a semi-trailer may be easier to reverse. The semi-trailer truck may have a smaller turning circle than a comparable rigid vehicle. The semi-trailer may be capable of hauling longer objects (e.g., tree trunks, piping, beams, railway track, etc.) than a full trailer. The semi-trailer may have greater load capacity, and a better ratio of cargo to vehicle weight. Some common widths of trailers may be 8 feet (2.44 m) and 2.6 m (8 ft 6.4 in).

Types of trailers may include a box, a bus, a curtain sider, a refrigerator trailer, a tanker, a dry bulk, a lowboy, a car carrying trailer, a drop deck trailer, a double decker trailer, and a side lifter. A box or van trailer may come in one of several standard lengths, including: 28 ft (8.53 m), 32 (9.75 m), 34 ft (10.36 m), 36 ft (10.97 m), 40 ft (12.19 m), 45 ft (13.72 m), 48 ft (14.63 m) and 53 ft (16.15 m). A bus trailer may be a bus bodied trailer hitched to a tractor unit to form a trailer bus, and it may be a simple alternative to building a rigid bus. A curtain sider may be similar to a box trailer, but the sides may be movable curtains made of reinforced fabric coated in with a waterproof coating. The curtain sider may include some of the security and weather resistance of a box trailer with advantages in loading of a flatbed. Refrigerator or reefer units may include a heating and/or cooling unit.

A tanker may be used to haul liquids (e.g., gasoline, milk, etc.). A dry bulk vehicle may be used to carry powder materials, such as sugar, flour and other dry powder materials. A flatbed may include a load floor and removable side rails. A lowboy may be a type of flatbed in which the load floor is closer to the ground than other flatbeds, and it may be used to haul heavy equipment, cranes, bulldozers, etc. A car carrying trailer may carry multiple cars. A drop-deck trailer may be a trailer in which the floor of the trailer drops to a lower level behind a tractor unit. A double decker may include a fixed, hinged, or movable second floor to allow them to carry additional palletized goods. Sidelifters may include hydraulic cranes mounted at both ends of the chassis to load and unload shipping containers without container handling equipment.

The suspension used with a commercial vehicle may include a system of springs, shock absorbers and linkages that connects a vehicle to its wheels. Suspension systems may improve handling and braking and protect the vehicle, cargo, and/or occupants from being injured or damaged by road noise, bumps, and vibrations. These goals may interfere with each other and result in a compromise of handling, braking, and/or protection given to the vehicle, its occupants, and its cargo.

A spring rate of a vehicle's suspension system may be a component in setting a vehicle's ride height or its location in the suspension stroke. Vehicles that carry heavy loads may have heavier springs to compensate for the additional weight that might otherwise collapse a vehicle to the bottom of its travel or suspension stroke. Heavier springs may also be used in applications where the suspension is frequently forced to the bottom of its stroke, which may cause a reduction in the useful amount of suspension travel and potentially to harsh bottoming.

Springs that are too hard or too soft may negatively affect a vehicle's handling, braking, and ability to protect vehicle contents from damage. Vehicles that commonly support substantial suspension loads may use heavy or hard springs with a spring rate close to an upper limit for the vehicle's weight. This may allow the vehicle to perform properly under a heavy load when control might be limited by inertia of the load. The same spring rate used with a much lower load may result in a high spring rate to vehicle weight ratio that could cause jarring and damage to the vehicle, the vehicle springs, and discomfort to vehicle occupants. In addition, vehicles with worn out or damaged springs may ride lower to the ground, which can reduce the overall amount of compression available to the suspension and may increase the amount of body lean when the vehicle turns.

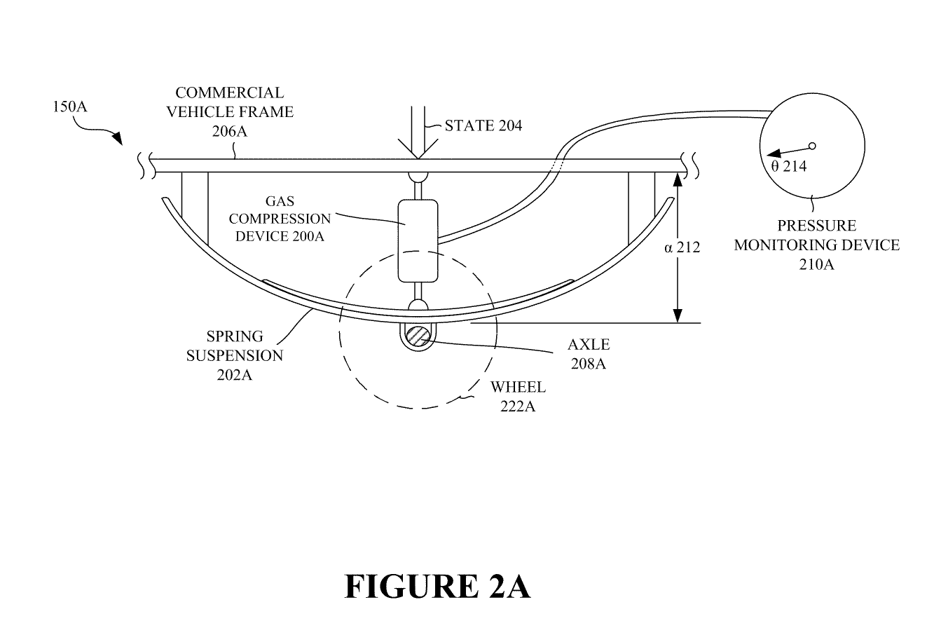

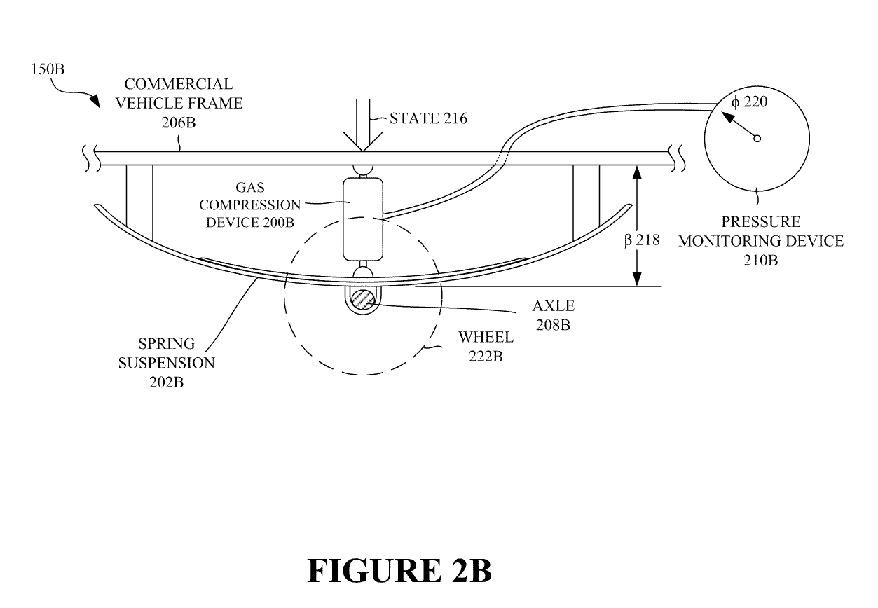

FIGS. 2A and 2B illustrate a side view of a suspension adaptation to measure load of the commercial vehicle of FIG. 1, according to an embodiment. In particular, FIGS. 2A and 2B illustrate a side view 150A-B, a gas compression device 200A-B, a spring suspension 202A-B, a state 204, a commercial vehicle frame 206A-B, an axle 208A-B, a pressure monitoring device 210A-B, a vertical distance α 212, a pressure θ 214, a state 216, a vertical distance β 218, a pressure φ 220, and a wheel 222A-B.

The gas compression device 200, 300, and 400 may represent alternate embodiments of each other, and may be used interchangeably with respect to the various Figures. Similarly, the commercial vehicle frame 206 and 306 may represent alternate embodiments. In addition, the pressure monitoring device 210 and 310 may also represent alternate embodiments of the same device (See FIGS. 2, 3 and 4).

In an embodiment, FIGS. 2A and 2B illustrate an increase in weight from the state 204 to the state 216, which causes the spring suspension 202A-B to be compressed. The weight may include goods to be transported and delivered, farm supplies, feed, machinery, appliances, cars, mobile homes, or other products that may be transported by a commercial vehicle. The commercial vehicle may be a tractor-trailer combination, a tractor, a trailer, or a combination of vehicles.

As illustrated in FIG. 2A, according to one embodiment, the weight associated with the state 204 may be applied to the commercial vehicle frame 206A. The weight may be an unloaded state, in which the weight compressing the spring suspension 202A includes the weight of the commercial vehicle without the weight of goods or items to be transported. A vertical distance α 212 between the base of the spring suspension 202A and a surface of the commercial vehicle frame 206A may be determined by the weight associated with the state 204. The spring suspension 202A may compress linearly or nonlinearly, depending on the spring suspension 202A characteristics. The spring suspension 202A may be a leaf spring system that may utilize more than one leaf spring.

In the embodiment, the weight associated with state 204 also compresses the gas compression device 200A. The gas compression device 200A in turn generates a gas pressure that is read by a pressure monitoring device 210A, which may be a mechanical and/or electronic device to monitor gas pressure. The gas compression device 200A may be coupled to the pressure monitoring device 210A using a ⅛th inch line. In the embodiment, the pressure generated by the gas compression device 200A in FIG. 2A is θ 214.

In another embodiment, the gas compression device 200A may contain a gas chamber that is caused to expand when the weight associated with the state 204 is applied to the commercial vehicle frame 206A. In the embodiment, a lower mount of the gas compression device 200A may be coupled to the commercial vehicle frame 206A and an upper mount of the gas compression device 200A may be coupled to the axle 208A. The gas compression device 200A may thereby act as a gas expansion device when a weight is added to the commercial vehicle, the spring suspension 202A is compressed, and the gas compression device 200A is elongated by the downwards movement of the lower mount coupled to the descending commercial vehicle frame 206A.

According to another embodiment, as illustrated in FIG. 2B, an additional weight associated with the state 216 may be applied to the commercial vehicle frame 206B. The additional weight associated with the state 216 may increase the weight of the commercial vehicle to a maximum allowable weight established by a government regulation. For instance, the weight associated with the state 216 may increase the overall gross vehicle weight of the commercial vehicle to approximately 80,000 pounds, which may be a federally established allowable limit for a type of commercial vehicle traveling on an interstate system. The additional weight associated with the state 216 may compress the spring suspension 202B, reducing the distance between the commercial vehicle frame 206B surface and the base of the spring suspension 202B from α 212 to β 218.

The additional weight may cause the commercial vehicle frame 206B and other load bearing parts of the commercial vehicle to deflect, compress, and/or deform, resulting in a vertical change in position. The vertical change in position may be measured between the axle 208B and the commercial vehicle frame 206B. The vertical change in position may be measured between the commercial vehicle frame 206B and a supporting surface of the commercial vehicle, such as a road or garage floor.

In addition, the additional weight may cause the tires and other portions of the suspension system of the commercial vehicle to be compressed and/or deflected. In the embodiment, the gas compression device 200B may be used to measure a change in distance and/or a force applied between the commercial vehicle frame 206B and an axle 208B coupled to the gas compression device 200B. The change in distance from α 212 to β 218 may cause the pressure of the gas contained within the gas compression device 200B to the pressure φ 220, which may be monitored by the pressure monitoring device 210B. The pressure φ 220 may correspond to an allowable loading level of the commercial vehicle in accordance with a government standard.

The gas compression device 200A-B may be installed to a stationary commercial vehicle without removing a wheel or a part of the spring suspension 202A-B. The gas compression device 200A-B may be installed on a commercial vehicle while all other parts of the commercial vehicle remain coupled together, including the wheels, suspension components, the commercial vehicle frame, and drive components. The gas compression device 200A-B may be installed between the axle 208A-B and the commercial vehicle frame 206A-B.

The pressure monitoring device 210A-B may be a mechanical device that provides an analog measurement of gas pressure. The pressure monitoring device 210A-B may be an electronic device and/or a software module used to determine a gas pressure. A processor and a memory may be used to process a gas pressure data of the pressure monitoring device 210A-B. When a desired pressure (e.g., the pressure φ 220, 80,000 lbs., etc.) the pressure monitoring device 210A-B may emit an audible tone, transmit a signal, activate or deactivate a light, change color, display an image, or otherwise perform an alert action to indicate that a desired weight has been reached.

In an alternate embodiment, the gas compression device 200A-B may be coupled to a surface supporting one or more of the tires of the commercial vehicle, such as a road surface or an asphalt surface. In the embodiment, the gas compression device 200A-B may be used to measure a change in distance and/or a force applied between the commercial vehicle frame 206A-B and a surface supporting one or more tires of the commercial vehicle.

The change in pressure obtained by the gas compression device 200A-B may be approximated by the ideal gas law, which may be the equation of state of a hypothetical ideal gas. The ideal gas law may include pressure, volume, and temperature. The equation may be: PV=nRT, where P may be the absolute pressure of the gas, V may be the volume of the gas, n may be the amount of substance of the gas, possibly measured in moles, R may be the gas constant (which may be 8.3145 J/(mol K)), and T may be the absolute temperature.

The pressure of the gas compression device 200A-B may increase as a gas volume controlled by the gas compression device 200A-B is increased and/or decreased. The pressure may be affected by the temperature of the environment and the gas compression device 200A-B. The volume of the gas compression device 200A-B may be linearly altered with respect to a change in distance between the commercial vehicle frame 206A-B and an axle 208A-B of the commercial vehicle.

The change in distance between the commercial vehicle frame 206A-B and the axle 208A-B of the commercial vehicle may vary nonlinearly or linearly with changes in weight supported by the commercial vehicle frame 206A-B. The change in distance may be repeatable with similar weights placed with similar distribution with respect to the commercial vehicle frame 206A-B. Altering the positioning of the weight, such as by placing the same weight substantially in front of or behind the axle 208A-B, may change a static and/or dynamic load supported by the axle 208A-B. The gas compression device 200A-B may generate a repeatable pressure achieved by supporting a similar weight with a similar distribution using the commercial vehicle frame 206A-B.

In another embodiment, the gas compression device 200A-B may be mounted substantially vertically between the axle 208A-B. An upper mount of the gas compression device 200A-B may be coupled to the commercial vehicle frame 206A-B by bolting, welding, or any other mechanism to create a mechanical connection. A lower mount of the gas compression device 200A-B may be coupled to the axle 208A-B. One end of the gas compression device 200A-B may be attached to an iron piston of the gas compression device, and an additional end of the gas compression device 200A-B may be attached to a generally cylindrical metallic housing of the gas compression device 200A-B. The end and the additional end may each act as either the upper or the lower mount of the gas compression device 200A-B.

In a further embodiment, the gas compression device 200A-B may be coupled between the commercial vehicle frame 206A-B and the axle 208A-B using a sliding or movable connection. The gas compression device 200A-B may be mounted at an angle between 0 and 90 degrees from vertical between the axle 208A-B and the commercial vehicle frame 206A-B. The gas compression device 200A-B may be mounted between the commercial vehicle frame 206A-B and a component of the spring suspension 202A-B (e.g., a forward portion of the leaf spring, a hinge, a slide, etc.).

In another embodiment, the gas compression device 200A-B may be coupled to the commercial vehicle frame 206A-B and a supporting surface of the commercial vehicle, such as a road surface, a ground level weighing station, or another surface. Loading the commercial vehicle may cause the gas compression device 200A-B to compress a gas chamber, resulting in a repeatable compression of gas with a change in vehicle height once a weight has been applied to the commercial vehicle frame 206A-B.

The spring suspension 202 system may include a leaf spring suspension 202A-B. The leaf spring suspension spring suspension 202A-B may include one or more leaf springs. The leaf spring may include an arc-shaped length of spring steel of rectangular cross-section. The center of the arc may provide a location of the axle 208A-B. The leaf spring may include a tie hole at one or more ends to attach the leaf spring to a vehicle body. The leaf spring may include one or more leaves stacked on top of each other in several layers, which may have progressively shorter leaves. The leaf spring may provide a locating, a damping, and/or a springing function. The leaf spring may be attached directly to the frame at one or both ends. An end of the leaf spring may be attached through a shackle, which may include a short swinging arm. The shackle may allow the leaf spring to elongate when compressed.

In another embodiment, an unloaded movement of the spring suspension 202A-B system may be reduced by using the gas compression device 200A-B to apply a force between the frame and the axle 208A-B of the commercial vehicle. When the commercial vehicle is empty or carrying a load below the maximum allowable weight, the spring suspension 202 system and/or the commercial vehicle frame 206A-B may be allowed to move through a range of motion that may cause discomfort to a commercial vehicle occupant and/or damage to cargo, the commercial vehicle, and/or the spring suspension 202A-B. The spring suspension 202A-B may be damaged by a range and/or a rate of motion that occurs through operation of a commercial vehicle on a roadway with less than the maximum allowable gross vehicle weight. The range and/or rate of motion of the spring suspension 202A-B and/or the commercial vehicle frame may exceed a safe level when potholes, bumps, speedbumps, and/or other road surfaces are encountered by a moving commercial vehicle.

The unloaded movement of the spring suspension 202A-B system may be slowed and/or limited by the gas compression device 200A-B mechanically coupled to the axle 208A-B and the commercial vehicle frame 206A-B. In addition, after the gas compression device 200A-B has been installed and inflated, the commercial vehicle frame 206A-B may be lifted away from the spring suspension 202A-B in an unloaded condition.

The gas compression device 200A-B may be inflated until it supports an unloaded weight of the commercial vehicle frame to provide an unloaded calibration pressure level. In addition, inflating the gas compression device 200A-B until it supports the frame may provide a sufficient travel range to compress the gas compression device 200A-B under an allowable loaded weight and to generate a predetermined loaded calibration pressure.

The gas compression device 200A-B may be installed by coupling the commercial vehicle frame 206A-B and the axle 208A-B without removing other vehicle parts or components. Pressurized air may be added to the gas compression device 200A-B until the frame is supported by the gas compression device 200A-B rather than the spring suspension 202A-B. Inflating the gas compression device 200A-B may lift the commercial vehicle frame 206A-B away from the spring suspension 202A-B. Adding air to the gas compression device 200A-B may increase an expansion force applied between the commercial vehicle frame 206A-B and the axle 208A-B by the gas compression device 200A-B.

The expansion force applied by the gas compression device 200A-B may reduce the load supported by the spring suspension 202A-B when the commercial vehicle frame 206A-B supports less than the load allowed by governmental regulations or in an unloaded condition. The supporting or expansion force applied by the gas compression device 200A-B may also reduce a likelihood of impact damage and/or fatigue failure of the spring suspension 202A-B system through limiting an unloaded range of motion and/or a frequency of impact occurrence between the spring suspension 202A-B and the commercial vehicle frame 206A-B.

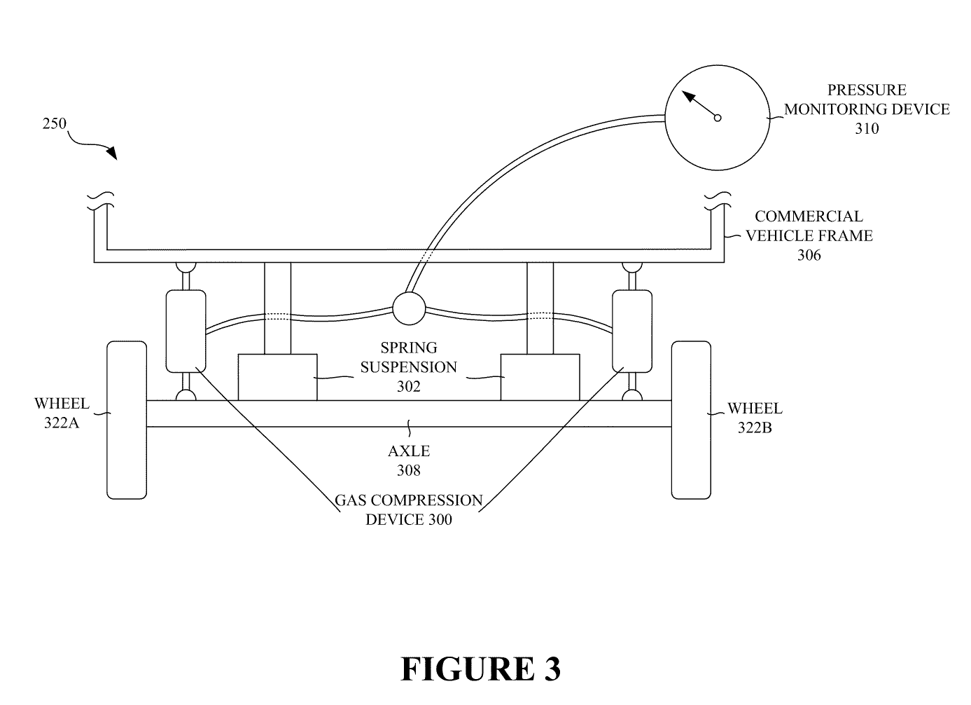

FIG. 3 illustrates a rear view 250 of a suspension adaptation to measure load of the commercial vehicle of FIG. 1, according to an embodiment. In particular, FIG. 3 illustrates a rear view 250, a gas compression device 300, a spring suspension 302, a commercial vehicle frame 306, an axle 308, a pressure monitoring device 310, and a wheel 322A-B.

In an embodiment, a pressure change between the gas compression device 300 and an additional gas compression device 300 may be balanced. The gas compression devices 300 may be mounted to the same and/or different axles on different sides of the commercial vehicle, and they may be coupled to share and distribute gas pressure between them. A combined gas pressure may be monitored by the pressure monitoring device 310. An air line of the gas compression device 300 and the additional gas compression device 300 may be coupled together using a T-valve. The air line of the gas compression device 300 may be ⅛th inch.

Balancing the pressure reading between two or more gas compression devices 300 may allow a combined reading to indicate whether an allowable weight has been reached on an unlevel loading surface. The unlevel loading surface may alter a pitch or a roll the commercial vehicle, making a front, rear, left, or right side higher than another side.

In an additional embodiment, individual gas compression devices 300 may be used to provide separate gas pressure readings to indicate whether each spring set of a spring suspension 302 system has been compressed to a predetermined level that corresponds to an allowable weight limit. In other words, a separate gas compression device 300 may be used to measure a change in height with respect to an individual wheel and/or set of wheels to determine whether a predetermined acceptable loading level of the commercial vehicle has been reached.

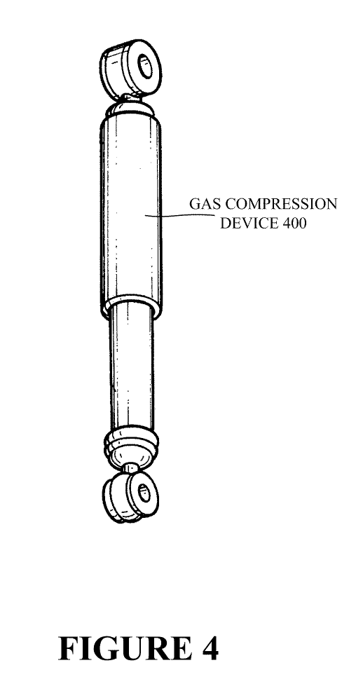

FIG. 4 illustrates a gas compression device 400, according to one embodiment. The gas compression device 200, 300, and 400 may be alternate embodiments of each other. The gas compression device 400 may be an automotive air shock. The automotive air shock may include an adjustable pressure range between 10 and 200 pounds per square inch. A portable gas compressor may be used to inflate and/or deflate the gas compression device 400 through the adjustable pressure range. The portable gas compressor may be powered using an automobile battery.

The automotive air shock may typically be used on vehicles with less than a 10,000 lb. gross vehicle weight to level a non-commercial vehicle's ride height when additional weight is supported by the vehicle. The automotive air shock may include a sintered iron piston, full displaced valving, a lubricated air sleeve, and/or a ½ inch piston rod. The gas compression device 400 may include a generally cylindrical metallic housing. The generally cylindrical metallic housing may enclose and support the sintered iron piston.

In an embodiment, the gas compression device 400 (e.g., the automotive air shock, an air bag spring, an air ram, etc.) may include a compressed length between approximately 5 and 30 inches. The gas compression device 400 may include an extended length between approximately 7 and 40 inches. The gas compression device 400 may include a travel length between approximately 1 and 13 inches.

In an embodiment, the gas compression device 400 is an automotive air shock that resists bending moments and non-axial translational forces using the rigid walls of the piston and cylindrical metallic housing. In other embodiments, the gas compression device 400 may be any type of gas compression device typically used with a vehicle with less than a 10,000 lb. gross vehicle weight, such as an air bag spring or an air ram. The air bag spring or air ram may be used to level a non-commercial vehicle's ride height. The air bag spring or air ram may be used to improve a ride quality of a non-commercial vehicle. The gas compression device 400, such as the automotive air shock, air bag spring or air ram, may be rated to support a threshold weight limit. The threshold weight limit may be below approximately 10,000 lbs.

The air bag spring may be a flexible walled air compression device. The walls of the air bag spring may be made of an elastic or pliable material such as a type of rubber or polyurethane. The air bag spring may operate as a replacement for a non-commercial vehicle spring suspension system, or it may be designed to operate in conjunction with a non-commercial vehicle spring suspension to improve a ride quality or level an overloaded vehicle. The air bag spring may include a coil spring that encloses the flexible walls of the air bag spring. The flexible walls of the air bag spring may be designed to expand outwards when the air bag spring is compressed. The air bag spring ends may rotate and/or translate with respect to each other in response to non-axial bending moments and translational forces subject to the bending and or stretching characteristics of the flexible wall material.

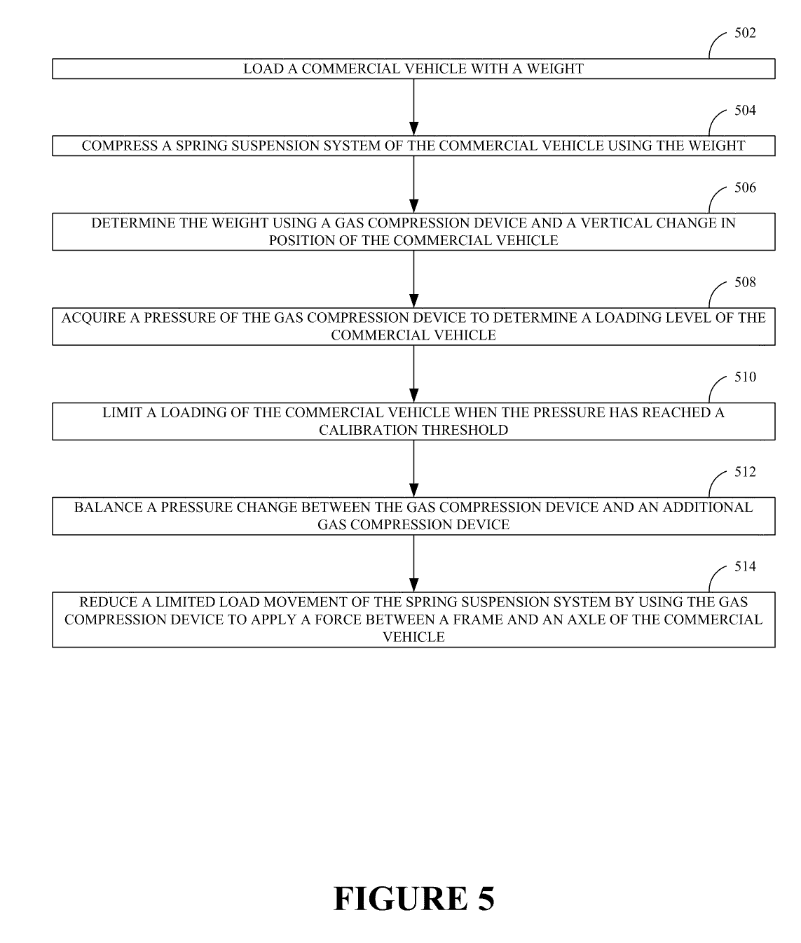

FIG. 5 illustrates a process flow to determine a weight using a gas compression device 200A-B and a vertical change in position, according to one embodiment. In operation 502, a commercial vehicle is loaded with a weight. In operation 504, a spring suspension 202A-B system of the commercial vehicle is compressed using the weight. In operation 506, the weight is determined using a gas compression device 200A-B and a vertical change in position of the commercial vehicle. In operation 508, a pressure of the gas compression device 200A-B is acquired to determine a loading level of the commercial vehicle.

In operation 510, a loading of the commercial vehicle is limited when the pressure has reached a calibration threshold. In operation 512, a pressure change in balanced between the gas compression device 200A-B and an additional gas compression device 300. In operation 514, a limited load movement of the spring suspension 202A-B system is reduced by using the gas compression device 200A-B to apply a force between a frame and an axle 208A-B of the commercial vehicle. As the spring suspension 202A-B compresses and expands, the gas compression device 200A-B also is compressed and expanded. The gas compression device 200A-B may expand and/or contract more slowly than the spring suspension 202A-B due to internal friction. The gas compression device 200A-B, once installed and inflated, may also reduce contact between the commercial vehicle frame 206A-B.

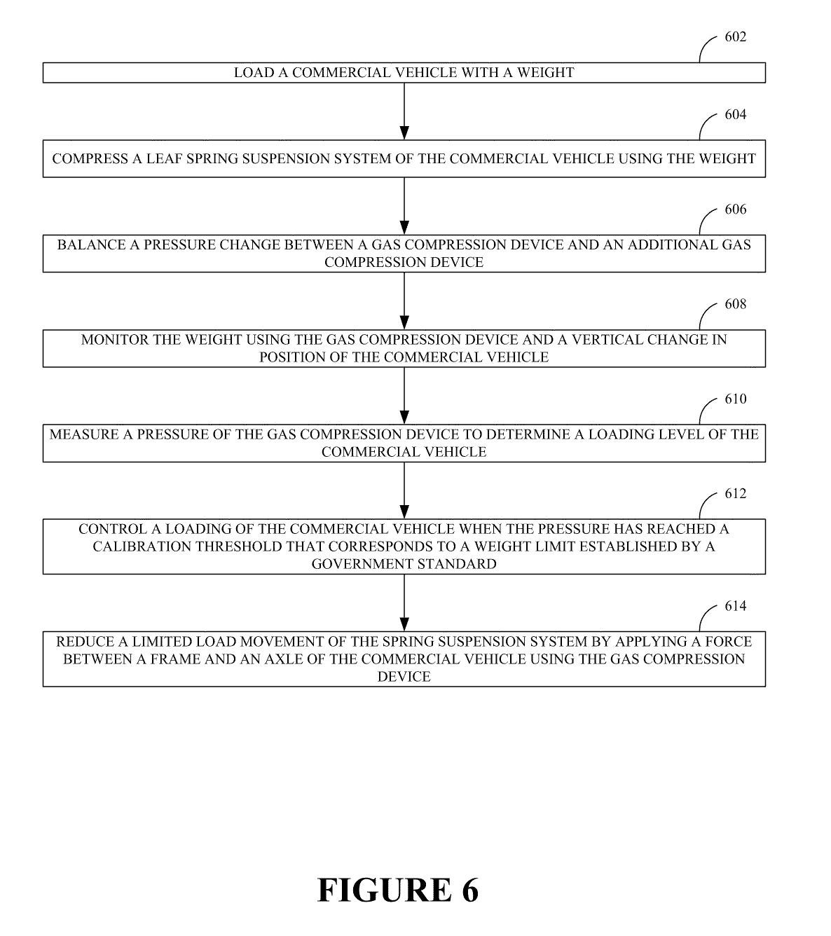

FIG. 6 illustrates a process flow to control a loading of the commercial vehicle when a pressure has reached a calibration threshold, according to one embodiment. In operation 602, a commercial vehicle is loaded with a weight. In operation 604, a leaf spring suspension 202A-B system of the commercial vehicle is compressed using the weight. In operation 606, a pressure change is balanced between a gas compression device 200A-B and an additional gas compression device 300. In operation 608, the weight is monitored using the gas compression device 200A-B and a vertical change in position of the commercial vehicle. In operation 610, a pressure of the gas compression device 200 is measured to determine a loading level of the commercial vehicle. In operation 612, a loading of the commercial vehicle is controlled when the pressure has reached a calibration threshold that corresponds to a weight limit established by a government standard. In operation 614, a limited load movement of the spring suspension 202 system is reduced by applying a force between a frame and an axle 208A-B of the commercial vehicle using the gas compression device 200A-B.

Although the present embodiments have been described with reference to specific example embodiments, it will be evident that various modifications and changes may be made to these embodiments without departing from the broader spirit and scope of the various embodiments. For example, the various devices, etc. described herein may be enabled and operated using hardware circuitry (e.g., CMOS based logic circuitry), firmware, software and/or any combination of hardware, firmware, and/or software (e.g., embodied in a machine readable medium). For example, various electrical structures and methods may be embodied using transistors, logic gates, and electrical circuits.

It will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed, is:

1. A load measurement method, comprising:
loading a commercial vehicle with a weight;
compressing a spring suspension system of the commercial vehicle using the weight;
determining the weight using a gas compression device and a vertical change in position of the commercial vehicle; and
acquiring a pressure of the gas compression device to determine a loading level of the commercial vehicle.

2. The load measurement method of claim 1, wherein the spring suspension system is comprised of a leaf spring suspension.

3. The load measurement method of claim 1, further comprising:
limiting a loading of the commercial vehicle when the pressure has reached a calibration threshold.

4. The load measurement method of claim 3, wherein the calibration threshold corresponds to a weight limit established by a government standard.

5. The load measurement method of claim 1, wherein the vertical change in position is measured using a compression distance of the spring suspension system.

6. The load measurement method of claim 5, wherein the spring suspension system is comprised of a leaf spring.

7. The load measurement method of claim 1, wherein the gas compression device is mechanically coupled to an axle and a frame of the commercial vehicle.

8. The load measurement method of claim 7, wherein the gas compression device is an automotive air shock.

9. The load measurement method of claim 8, wherein the automotive air shock is comprised of an adjustable pressure range between 10 and 200 pounds per square inch.

10. The load measurement method of claim 1, further comprising:
balancing a pressure change between the gas compression device an additional gas compression device, wherein the gas compression device and the additional gas compression device are mounted on different sides of the commercial vehicle.

11. The load measurement method of claim 1, further comprising:
reducing a diminished load movement of the spring suspension system by using the gas compression device to apply a force between a frame and an axle of the commercial vehicle.

12. A load measurement system, comprising:
a commercial vehicle that is loaded with a weight;
a spring suspension system of the commercial vehicle that is compressed using the weight;
a gas compression device that is used to determine the weight and a vertical change in position of the commercial vehicle; and
a pressure monitor to acquire a pressure of the gas compression device to determine a loading level of the commercial vehicle.

13. The load measurement system of claim 12, wherein the spring suspension system is comprised of a leaf spring suspension.

14. The load measurement system of claim 12, wherein a loading of the commercial vehicle is limited when the pressure has reached a calibration threshold.

15. The load measurement system of claim 14, wherein the calibration threshold corresponds to a weight limit established by a government standard.

16. The load measurement system of claim 12, wherein the vertical change in position is measured using a compression distance of the spring suspension system.

17. The load measurement system of claim 16, wherein the spring suspension system is comprised of a leaf spring.

18. The load measurement system of claim 12, wherein the gas compression device is mechanically coupled to an axle and a frame of the commercial vehicle.

19. The load measurement system of claim 18, wherein the gas compression device is an automotive air shock.

20. A load measurement method, comprising:
loading a commercial vehicle with a weight;
compressing a leaf spring suspension system of the commercial vehicle using the weight;
balancing a pressure change between a gas compression device and an additional gas compression device, wherein the gas compression device and the additional gas compression device are mounted on different sides of the commercial vehicle.
monitoring the weight using the gas compression device and a vertical change in position of the commercial vehicle, wherein the vertical change in position is measured using a compression distance of the spring suspension system;
measuring a pressure of the gas compression device to determine a loading level of the commercial vehicle, wherein the gas compression device is mechanically coupled to an axle and a frame of the commercial vehicle, wherein the gas compression device is an automotive air shock with an adjustable pressure range between 10 and 200 pounds per square inch;
controlling a loading of the commercial vehicle when the pressure has reached a calibration threshold that corresponds to a weight limit established by a government standard; and
reducing a limited load movement of the spring suspension system by applying a force between a frame and an axle of the commercial vehicle using the gas compression device.
